(19) United States
(12) Patent Application Publication
(10) Pub. No.: US 2015/0123974 A1
(43) Pub. Date: May 7, 2015

(54) Visualization Method Of Entire Grid Data Of Numerical Weather Prediction Model Having Ultra-High Grid Resolution By Magnification Mode And Hardware Device Performing The Same

(71) Applicant: Korea Institute of Atmospheric Perdiction Systems, Seoul (KR)

(72) Inventors: Dong-Chan JOO, Seoul (KR); Ki-Hwan KIM, Seoul (KR); Seol-Eun SHIN, Seoul (KR)

(21) Appl. No.: 14/088,582

(22) Filed: Nov. 25, 2013

(30) Foreign Application Priority Data
Nov. 7, 2013 (KR) 10-2013-0134663

(51) Int. Cl. G09G 5/391; G06T 3/40

(52) U.S. Cl. CPC G09G 5/391; G06T 3/4092; G09G 2340/0407; G09G 2340/045; G09G 2340/0457; G06T 2200/28
USPC 345/428

(57) ABSTRACT

A method of visualizing entire grid data of numerical weather prediction model having an ultra-high grid resolution by a magnification mode is disclosed. Original data having a first data resolution computed in a numerical weather prediction model is converted into a first low-resolution data having a second data resolution. The second data resolution is lower than the first data resolution. The first low-resolution data is displayed as a first entire image including a plurality of first unit images. The original data is converted into a second low-resolution data having a third data resolution based on a first input signal. The third data resolution is lower than the first data resolution and higher than the second data resolution. The second low-resolution data is displayed as a first partial image including a plurality of second unit images.

### TECHNICAL FIELD

Example embodiments of the invention relate to a visualization method of numerical weather prediction model data and a hardware device performing the same. More particularly, example embodiments of the invention relate to a visualization method of entire grid data of numerical weather prediction model having an ultra-high grid resolution by a magnification mode and a hardware device performing the same.

### DESCRIPTION OF THE RELATED ART

A numerical weather prediction (“NWP”) model is a mathematical model to compute a plurality of equations including dynamic equations and physical parameterization equations of atmosphere and ocean in order to predict a future weather condition from current or past weather conditions. The NWP model may include a dynamic core part which is important to compute the dynamic equations. The dynamic core part may describe physical quantities such as, e.g., wind, temperature, pressure, humidity, entropy, etc. as primitive equations including a plurality of partial differential equations. The dynamic core part may numerically solve a solution of the primitive equations.

A computation method for the partial differential equations may be required to compute the primitive equations as well as information on positions of variables in the primitive equations. The information on positions of variables in the primitive equations may be acquired using a spherical coordinates system to indicate horizontal and vertical positions on the Earth. For example, a conventional latitude-longitude coordinates system may be used to indicate horizontal positions of the variables. Also, a vertical coordinates system such as, e.g., a pressure height, or a sea surface height may be used to indicate vertical positions of the variables. The computation method for the partial differential equations may include a spectral element method. The spectral element method may divide a whole computational space into a plurality of element spaces.

Technologies have been developed to improve a super-computer for the NWP model. For example, horizontal grid resolution of the NWP model may be finer than, e.g., about 20 km×20 km.

### CONTENT OF THE INVENTION

### Technical Object of the Invention

One or more example embodiment of the invention provides a visualization method of entire grid data of numerical weather prediction model having an ultra-high grid resolution by a magnification mode, thereby entirely visualizing data of the numerical weather prediction model regardless of a grid resolution of the numerical weather prediction model.

Also, another example embodiment of the invention provides a hardware device performing the visualization method of the entire grid data of the numerical weather prediction model having the ultra-high grid resolution by the magnification mode.

### Contruction and Operation of the Invention

In an example embodiment of a visualization method of entire grid data of numerical weather prediction model having an ultra-high grid resolution by a magnification mode, original data having a first data resolution computed in a numerical weather prediction model is converted into a first low-resolution data having a second data resolution. The second data resolution is lower than the first data resolution. The first low-resolution data is displayed as a first entire image including a plurality of first unit images which corresponds to portions of the first low-resolution data. The original data is converted into a second low-resolution data having a third data resolution based on a first input signal. The third data resolution is lower than the first data resolution and higher than the second data resolution. The second low-resolution data is displayed as a first partial image including a plurality of second unit images which corresponds to portions of the second low-resolution data.

In an example embodiment, the original data may be further converted into a third low-resolution data having a fourth data resolution based on a second input signal. The fourth data resolution may be lower than the first data resolution and higher than the third data resolution. The third low-resolution data may be displayed as a second partial image including a plurality of third unit images which corresponds to portions of the third low-resolution data.

In an example embodiment, the original data may be further displayed as a third partial image based on a third input signal. The first data resolution may be equal to a first pixel resolution of a display part.

In an example embodiment, the third data resolution may be four times greater than the second data resolution.

In an example embodiment, the first data resolution may have a horizontal grid scale between zero and 10 km in a side. The second data resolution may be between 1/100 and 1/10 of the first data resolution.

In an example embodiment of a hardware device performing a visualization method of entire grid data of numerical weather prediction model having an ultra-high grid resolution by a magnification mode, the hardware device includes a processor configured to convert original data having a first data resolution computed in a numerical weather prediction model into a first low-resolution data having a second data resolution, a display part having a first pixel resolution and configured to display the first low-resolution data as a first entire image and an input part configured to provide the processor with a first input signal for executing a first magnification mode. The second data resolution is lower than the first data resolution. The first entire image includes a plurality of first unit images which corresponds to portions of the first low-resolution data. The processor is configured to convert the original data into a second low-resolution data having a third data resolution based on the first input signal. The third data resolution is lower than the first data resolution and higher than the second data resolution. The display part is configured to display the second low-resolution data as a first partial image. The first partial image includes a plurality of second unit images which corresponds to portions of the second low-resolution data.

In an example embodiment, the input part may be further configured to provide the processor with a second input signal for executing a second magnification mode. The processor may be further configured to convert the original data into a third low-resolution data having a fourth data resolution based on the second input signal. The fourth data resolution may be lower than the first data resolution and higher than the third data resolution. The display part may be further configured to display the third low-resolution data as a second partial image. The second partial image may include a plurality of third unit images which corresponds to portions of the third low-resolution data.

In an example embodiment, the input part may be further configured to provide the processor with a third input signal for executing a third magnification mode. The processor may be further configured to instruct the display part for displaying the original data as a third partial image based on the third input signal. The first data resolution may be equal to the first pixel resolution.

In an example embodiment, the third data resolution may be four times greater than the second data resolution.

In an example embodiment, the first data resolution may have a horizontal grid scale between zero and 10 km in a side. The second data resolution may be between 1/100 and 1/10 of the first data resolution.

### Effect of the Invention

According to one or more example embodiment of the visualization method of entire grid data of numerical weather prediction model having the ultra-high grid resolution by the magnification mode and the hardware device performing the same, numerical weather prediction model data having the ultra-high grid resolution may be displayed as a first resolution image including a plurality of unit images based on a magnification level of the magnification mode, thereby visualizing the numerical weather prediction model data without reducing accuracy of the numerical weather prediction model data regardless of the pixel resolution of the display part.

Also, a second resolution image including more unit images than the first resolution image may be displayed as the magnification level of the magnification mode increases, thereby easily representing local or global distribution of atmospheric and/or oceanic physical quantity.

### BRIEF EXPLANATION OF THE DRAWINGS

The above and other features and advantages of the invention will become more apparent by describing in detailed example embodiments thereof with reference to the accompanying drawings, in which:

FIG. 1 is a block diagram illustrating a hardware device performing a method of visualizing entire grid data of numerical weather prediction model having an ultra-high resolution by a magnification mode according to an example embodiment of the invention;

FIG. 2 is a plan view illustrating a display part in the hardware device in FIG. 1;

FIG. 3A is a plan view illustrating numerical weather prediction model data visualized on a plane according to an example embodiment of the invention;

FIG. 3B is a perspective view illustrating numerical weather prediction model data visualized on a sphere according to an example embodiment of the invention;

FIG. 4 is a flowchart illustrating a method of visualizing entire grid data of numerical weather prediction model having an ultra-high resolution by a magnification mode;

FIG. 5A, FIG. 5B and FIG. 5C are plan views illustrating numerical weather prediction model data visualized on planes which are divided by a plurality of unit images based on a desired resolution respectively;

FIG. 6 is a perspective view illustrating a plurality of unit images in a spherical visualization of numerical weather prediction model data;

FIG. 7A, FIG. 7B and FIG. 7C are front views illustrating a display part which implements planar visualizations of numerical weather prediction model data having an ultra-high resolution respectively; and

FIG. 8A, FIG. 8B, FIG. 8C and FIG. 8D are front views illustrating a display part which implements spherical visualizations of numerical weather prediction model data having an ultra-high resolution respectively.

### DETAILED DESCRIPTION OF THE INVENTION

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in further detail with reference to the accompanying drawings.

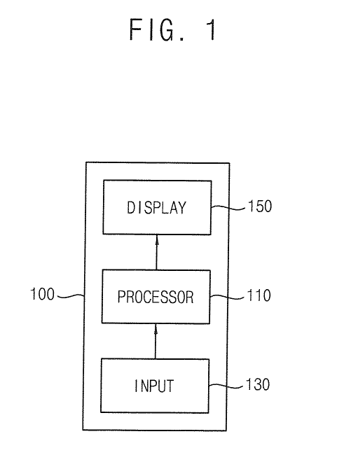

FIG. 1 is a block diagram illustrating a hardware device performing a method of visualizing entire grid data of numerical weather prediction model having an ultra-high resolution by a magnification mode according to an example embodiment of the invention.

Referring to FIG. 1, a hardware device 100 performing a method of visualizing entire grid data of numerical weather prediction model having an ultra-high resolution by a magnification mode according to the present example embodiment may include a processor 110, an input part 130 and a display part 150. The processor 110 may include a memory and at least one of central processing units (CPUs). The processor 110 may be configured to numerically compute a plurality of partial differential equations in a numerical weather prediction model. For example, the CPUs may be configured to compute dynamic equations of atmosphere and/or ocean to generate values of physical quantities such as, e.g., temperature, wind, humidity, entropy, etc. at a predetermined time step. The values of the physical quantities may be stored in the memory of the processor 110. In another example embodiment, the processor 110 may include a conventional CPU embedded in a smart device such as, e.g., a smart phone, a tablet PC, etc. The memory of the processor 110 may be configured to store numerical weather prediction model data which is received from an external server including a plurality of computing units.

The input part 130 may include an input device such as, e.g., a keyboard, a mouse, a touch screen, etc. For example, the input part 130 may include the keyboard or the mouse which may be used in a conventional personal computer. For example, the keyboard may include a control key (Ctrl), a shift key (Shift), etc. For example, the mouse may include a left button, a right button and a wheel therebetween. For example, the input part 130 may include a capacitance-type touch screen, a resistive-type touch screen, etc. The input part 130 may be integrally formed with the display part 150.

The display part 150 may be configured to display a color image or a black-and-white image based on an electrical signal from the processor 110.

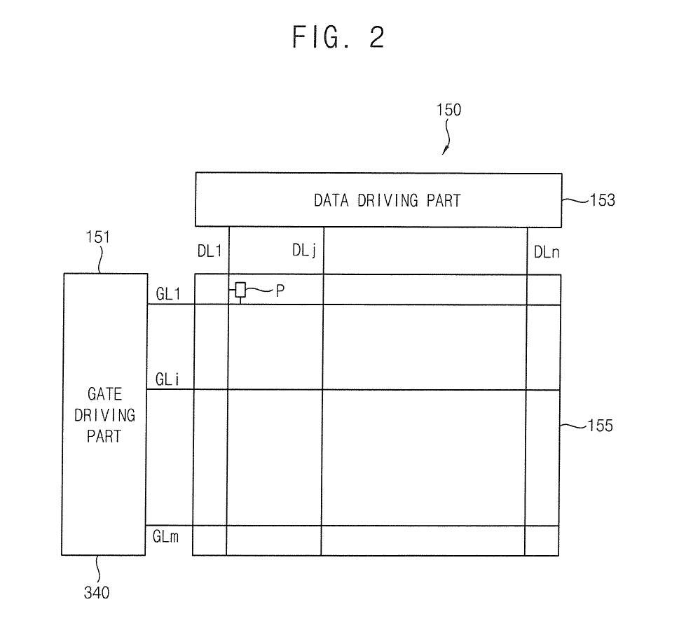

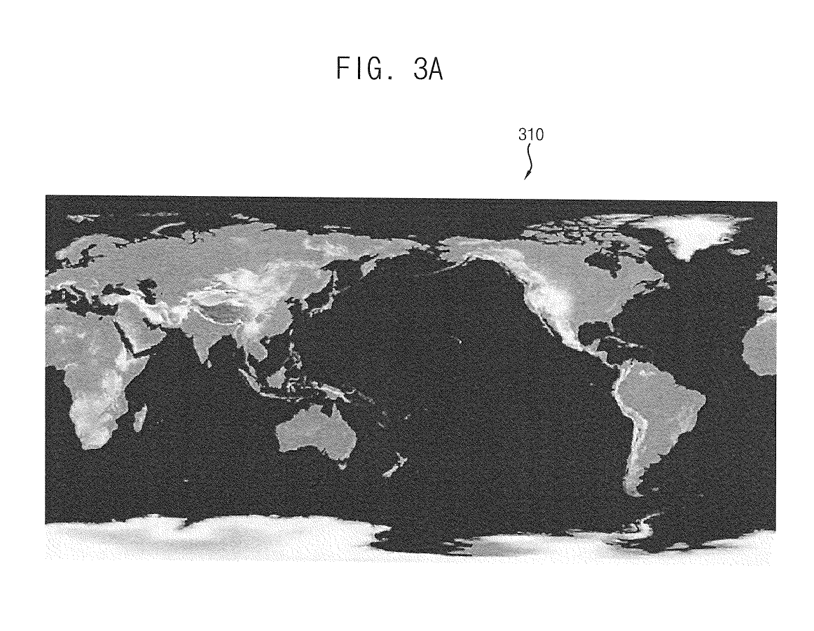

FIG. 2 is a plan view illustrating a display part in the hardware device in FIG. 1.

Referring to FIG. 2, the display part 150 may include, a liquid crystal display (LCD) device, an organic light emitting display (OLED) device, a plasma display panel (PDP) device, etc.

The LCD device may include a liquid crystal display panel and a backlight assembly. The liquid crystal display panel may include a first array substrate, a first opposing substrate and a liquid crystal layer therebetween. The backlight assembly may be configured to generate light toward the liquid crystal display panel. The first array substrate may include a plurality of gate lines GL1, GLi and GLm, a plurality of data lines DL1, DLj and DLn, a gate driving part 151 configured to drive the gate lines GL1, GLi and GLm, a data driving part 153 configured to drive the data lines DL1, DLj and DLn, a plurality of first switching elements and a plurality of pixel electrodes. The gate driving part 151 may be configured to sequentially provide the gate lines GL1, GLi and GLm with gate on/off signals. The data driving part 153 may be configured to provide the data lines DL1, DLj and DLn with data signals. The gate driving part 151 and the data driving part 153 may be configured to provide the gate on/off signals and the data signals based on an image control signal from the processor 110, respectively. The first switching elements may be electrically connected to the gate lines GL1, GLi and GLm and the data lines DL1, DLj and DLn, respectively, to control the pixel electrodes. The pixel electrodes may include, for example, a first pixel electrode in a red area, a second pixel electrode in a green area, a third pixel electrode in a blue area, etc. The first pixel electrode, the second pixel electrode, the third pixel electrode and at least three of the first switching elements may be disposed in one of a plurality of pixels P. For example, red light, green light, blue light, or a mixed light thereof may emit through the pixels P. The pixels P may be arranged in a matrix shape in a display area 155 of the first array substrate. For example, 1280×720 pixels P may be arranged in a unit square inch area (i.e., an area of 1 inch×1 inch) for a high definition (“HD”)-720 resolution display device. For example, 1920×1080 pixels P may be arranged in the unit square inch area for HD-1080 resolution display device. For example, 3840×2160 pixels P may be arranged in the unit square inch area for an ultra-high definition (“UHD”) display device. Resolutions of the pixels P may be varied according to example embodiments. If the display part 150 includes the LCD device, then liquid crystal molecules in the liquid crystal layer may be aligned to adjust luminance of the light from the backlight assembly, thereby displaying a color image or a black-and-white image.

If the display part 150 includes the OLED device, the OLED device may include a second array substrate, a plurality of organic light emitting display elements and a second opposing substrate. The organic light emitting display elements may be disposed on the second array substrate. The second opposing substrate may encapsulate the organic light emitting display elements. The second array substrate may include the gate lines GL1, GLi and GLm, the data lines DL1, DLj and DLn and a plurality of second switching elements which are electrically connected to the organic light emitting display elements. The gate driving part 151 and the data driving part 153 may be configured to provide the gate on/off signals and the data signals based on an image control signal from the processor 110, respectively. The organic light emitting display elements may include a red light emitting element, a green light emitting element and a blue light emitting element. The second switching elements may be configured to control turn-on and turn-off state of the red light emitting element, the green light emitting element and the blue light emitting element. The red light emitting element, the green light emitting element, the blue light emitting element and at least three of the second switching elements may be disposed in one of a plurality of pixels P. For example, red light, green light, blue light, or a mixed light thereof may emit through the pixels P. The pixels P may be arranged in a matrix shape in a display area 155 of the second array substrate. For example, 1280×720 pixels P may be arranged in a unit square inch area (i.e., an area of 1 inch×1 inch) for a high definition (“HD”)-720 resolution display device. For example, 1920×1080 pixels P may be arranged in the unit square inch area for HD-1080 resolution display device. For example, 3840×2160 pixels P may be arranged in the unit square inch area for an ultra-high definition (“UHD”) resolution display device. Resolution of the pixels P may be varied according to example embodiments. If the display part 150 includes the OLED device, then a desired color light may be generated from the organic light emitting display elements to display a color image.

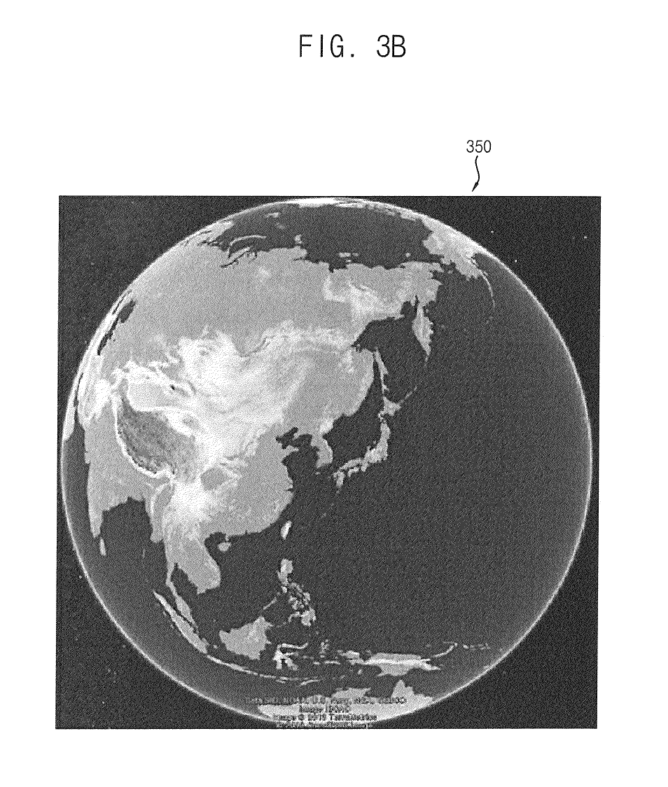

FIG. 3A is a plan view illustrating numerical weather prediction model data visualized on a plane according to an example embodiment of the invention. FIG. 3B is a perspective view illustrating numerical weather prediction model data visualized on a sphere according to an example embodiment of the invention.

Referring to FIG. 1, FIG. 2, FIG. 3A and FIG. 3B, numerical weather prediction model data may be visualized on a plane 310 or on a sphere 350. The numerical weather prediction model data may include values of a desired physical quantity at a plurality of grid points. The grid points may be defined in a spherical coordinates system such as, e.g., a latitude-longitude coordinates system, a cubed-sphere coordinates system, etc. The values of the physical quantity may be visualized by a variety of ways such as, isopleths, shading, hue, etc. on the plane 310 or on the sphere 350 based on a predetermined projection method of the spherical coordinates system.

Performance of a super-computer which numerically computes a numerical weather prediction model and algorithms for solving a plurality of equations in the numerical weather prediction model may be improved, thereby increasing a grid resolution of the numerical weather prediction model. For example, if the horizontal grid scale is 0.2 degrees×0.2 degrees in a latitude-longitude coordinates system, then actual horizontal grid distance on the Earth may be about 20 km×20 km. In this case, 1,800 (=360×5) pixels P in rows and 900 (=180×5) pixels P in columns may be required to represent numerical weather prediction model data having the horizontal grid scale of 0.2 degrees×0.2 degrees on the plane 310. If the display part 150 has the pixel resolution of 1280×720 (i.e., HD-720 resolution), then about 2 inch×2 inch display area may be required to entirely visualize the numerical weather prediction model data having a horizontal grid scale of 0.2 degrees×0.2 degrees. If the display part 150 has a higher pixel resolution such as, e.g., the HD-1080 resolution, UHD resolution, etc., then the numerical weather prediction model data having the horizontal grid scale of 0.2 degrees×0.2 degrees may be entirely visualized within about 1 inch×1 inch display area.

As mentioned above, as the performance of the super-computer and the algorithms are improved, the grid resolution of the numerical weather prediction model may be higher than the above case. For example, a horizontal grid scale of the numerical weather prediction model may be 0.02 degrees×0.2 degrees (i.e., about 2 km×2 km). In this case, 18,000 (=360×50) pixels P in rows and 9,000 (=180×50) pixels P in columns may be required to represent numerical weather prediction model data having the horizontal grid scale of 0.02 degrees×0.02 degrees on the plane 310. If the display part 150 has the pixel resolution of 1280×720 (i.e., HD-720 resolution), then about 15 inch×15 inch display area may be required to entirely visualize the numerical weather prediction model data having the horizontal grid scale of 0.02 degrees×0.02 degrees.

However, the display area 155 capable of displaying a desired image in the display part 150 is limited in size by a manufacturing process of a display device such as, e.g., the LCD device, the OLED device, etc. Accordingly, if the display area 155 is smaller than about 15 inch×15 inch in size, then entire grid data of the numerical weather prediction model having the horizontal grid scale of 0.02 degrees×0.02 degrees may not be visualized due to insufficient pixels P of the display area 155. In this case, the numerical weather prediction model data may be interpolated and/or extrapolated to adjust horizontal grid resolution corresponding to the pixel resolution of the display area 155. Accordingly, the numerical weather prediction model data visualized on the display area 155 may be restricted in accuracy due to the pixel resolution of the display part 150.

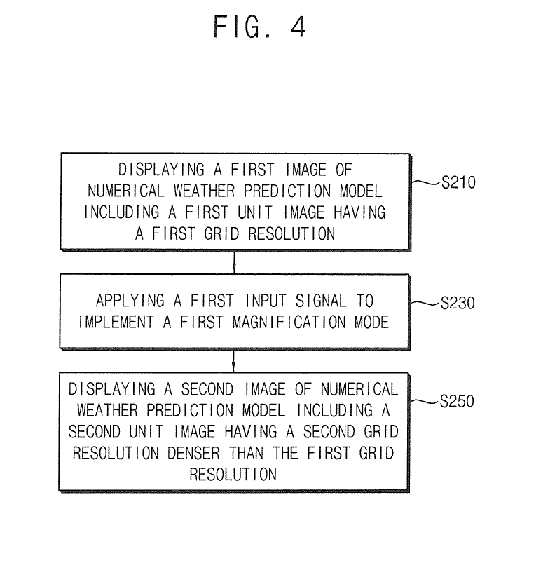

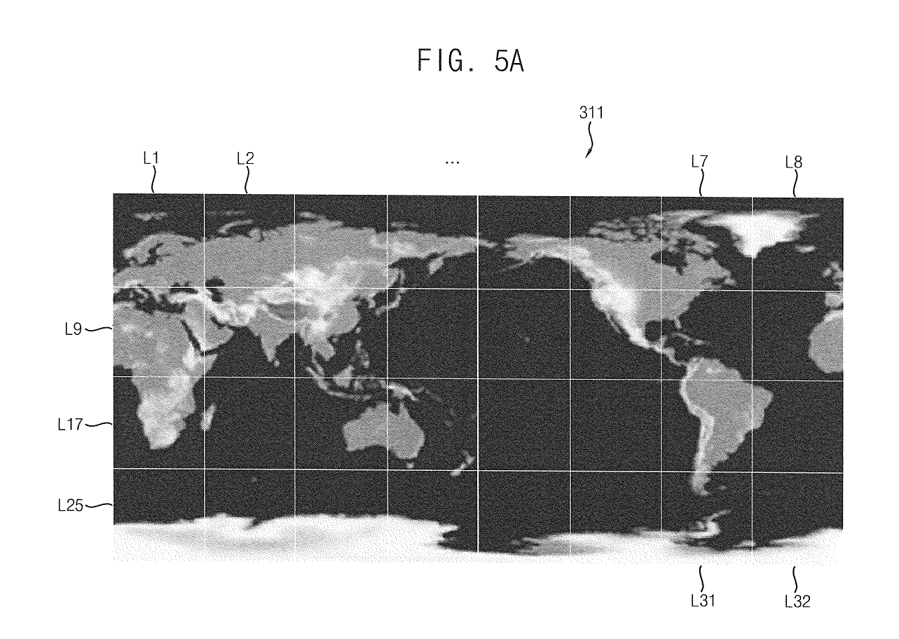

FIG. 4 is a flowchart illustrating a method of visualizing entire grid data of numerical weather prediction model having an ultra-high resolution by a magnification mode.

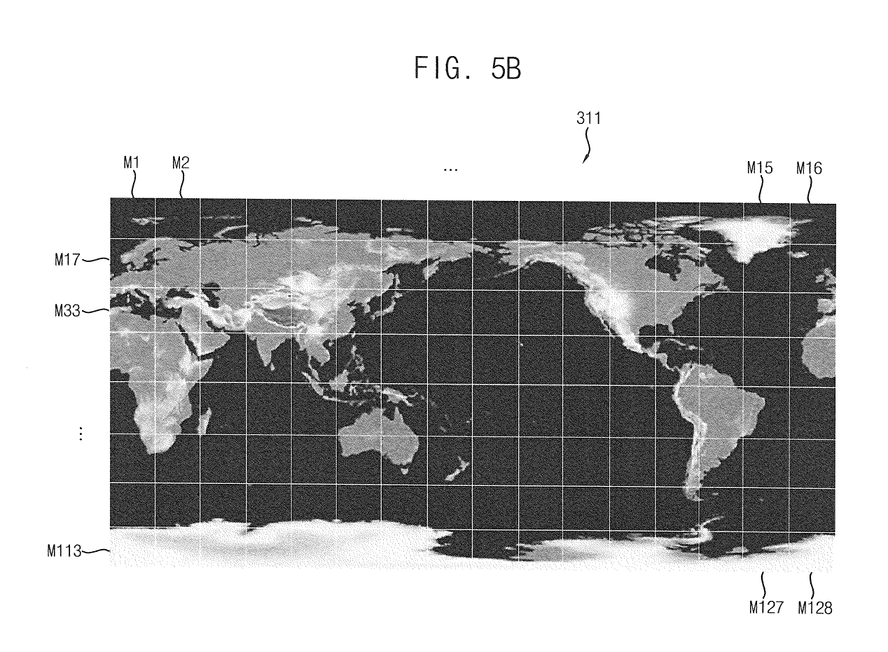

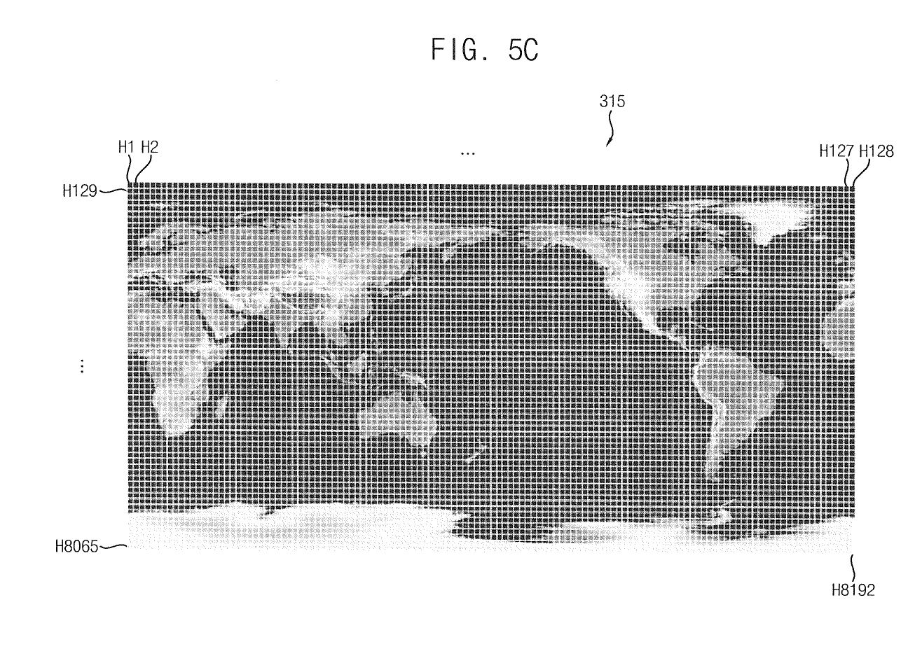

Referring to FIG. 4, in the method of visualizing entire grid data of numerical weather prediction model having an ultra-high resolution by a magnification mode according to the present example embodiment, a first image of the numerical weather prediction model data may be displayed in a step S210. The first image may include a plurality of first unit images having a first data resolution. A first input signal may be provided for executing a first magnification mode in a step S230. A second image of the numerical weather prediction model data may be displayed in a step S250. The second image may include a plurality of second unit images having a second data resolution. The second data resolution may be higher than the first data resolution. Each of the steps S210, S230 and S250 will be described in detail referring to FIG. 5A through FIG. 8D.

FIG. 5A, FIG. 5B and FIG. 5C are plan views illustrating numerical weather prediction model data visualized on planes which are divided by a plurality of unit images based on a desired resolution respectively.

Referring to FIG. 1, FIG. 2, FIG. 4 and FIG. 5A, the processor 110 may convert a resolution of original data computed in a numerical weather prediction model into a first data resolution. A first image 311 having the first data resolution may be displayed on the display part 150. The first image 311 may include a plurality of first unit images. For example, the first unit images may include a first sub-image L1, a second sub-image L2, a seventh sub-image L7, an eighth sub-image L8, a ninth sub-image L9, a seventeenth sub-image L17, a twenty-fifth sub-image L25, a thirty-first sub-image L31, a thirty-second sub-image L32, etc. The first sub-image L1 may include a geographical point which is zero degree in longitude and +90 degrees in latitude. The first sub-image L1 through the thirty-second sub-image L32 of the first unit images may have an order in a latitude direction or in a longitude direction. The sub-images L1 through L32 may include, for example, 256×256 grid resolution respectively which correspond to the pixel resolution of the display part 150. In the present example embodiment, the first image 311 may include 8 sub-images in a latitude direction and 4 sub-images in a longitude direction. Accordingly, the first image 311 may be displayed on a display area having 2048×1024 pixels P in the display part 150.

In the present example embodiment, the processor 110 may convert the resolution of the original data computed in the numerical weather prediction model into a low resolution corresponding to the 2048×1024 pixels P. For example, if the resolution of the original data has a grid scale of 0.01 degrees×0.01 degrees (=about 1 km×1 km) in a latitude-longitude coordinates system, a number of grid points to represent the original data may be 36,000 in rows and 18,000 in columns. The processor 110 may convert the resolution of the original data into the low resolution of a range between about 1/10 and about 1/100 in order to display the first image 311. For example, the processor 110 may convert the resolution of the original data into a low resolution of about 1/18 ratio. For example, 324 values at every 18×18 grid points may be interpolated into a single value at every grid point which is converted into the low resolution.

If the display part 150 has the pixel resolution of 1280×720 (i.e., HD-720 resolution), then the first image 311 may be displayed in about 1.6 inch×1.4 inch display area in the display part 150. Accordingly, global distribution of the original data computed in the numerical weather prediction model may be observed within a relatively narrow display area although a data resolution of the numerical weather prediction model reduces in the display part 150.

Referring to FIG. 1 and FIG. 4 again, a first input signal for executing a first magnification mode may be provided from the input part 130. If the input part 130 includes a computer keyboard, the first input signal may include, for example, a simultaneous or sequential input of a plurality of keys in a desired order. For example, the first input signal may include a simultaneous input of control key (Ctrl) with an alphabet “v” key. If the input part 130 includes a computer mouse, the first input signal may include, for example, a roll of a mouse-wheel. For example, the first input signal may include a roll of the mouse-wheel in a back-and-forth direction. If the input part 130 includes both the computer keyboard and the computer mouse, the first input signal may include the roll of the mouse-wheel in the back-and-forth direction while the control key (Ctrl) is turned on. If the input part 130 includes a touch screen, the input signal may include a touch or a slide on a specific display region of the touch screen. The input signal may be altered in various ways according to example embodiments.

Referring to FIG. 1, FIG. 2, FIG. 4 and FIG. 5B, the display part 150 may display a second image 313 having a second data resolution of the numerical weather prediction model. The second data resolution may be higher than the first data resolution. The second image 313 may include a plurality of second unit images. For example, the second unit images may include a first sub-image M1, a second sub-image M2, a fifteenth sub-image M15, a sixteenth sub-image M16, a seventeenth sub-image M17, a thirty-third sub-image M33, a one hundred thirteenth sub-image M113, a one hundred twenty-seventh sub-image M127, a one hundred twenty-eighth sub-image M128, etc. The first sub-image M1 may include a geographical point which is zero degree in longitude and +90 degrees in latitude. The first sub-image M1 through the one hundred twenty-eighth sub-image M128 of the second unit images may have an order in a latitude direction or in a longitude direction. The sub-images M1 through M128 may include, for example, 256×256 grid resolution respectively which correspond to the pixel resolution of the display part 150. In the present example embodiment, the second image 313 may include 16 sub-images in a latitude direction and 8 sub-images in a longitude direction. Accordingly, the second image 313 may be displayed on a display area having 4096×2048 pixels P in the display part 150.

In the present example embodiment, the processor 110 may convert the resolution of the original data computed in the numerical weather prediction model into a low resolution corresponding to the 4096×2048 pixels P. For example, a grid resolution of the numerical weather prediction model may be greater than zero and lower than about 10 km in a side. For example, if the resolution of the original data has a grid scale of 0.01 degrees×0.01 degrees (=about 1 km×1 km) in a latitude-longitude coordinates system, a number of grid points to represent the original data may be 36,000 in rows and 18,000 in columns. The processor 110 may convert the resolution of the original data into a low resolution of about 1/9 ratio. For example, 81 values at every 9×9 grid points may be interpolated into a single value at every grid point which is converted into the low resolution.

If the display part 150 has the pixel resolution of 1280×720 (i.e., HD-720 resolution), then the second image 313 may be displayed in about 3.2 inch×2.8 inch display area in the display part 150. Accordingly, a data resolution of the numerical weather prediction model may increase in the second image 313 more than that of the first image 133, and local or global distribution of the original data computed in the numerical weather prediction model may be observed within a relatively wider display area.

Referring to FIG. 1, FIG. 2, FIG. 4 and FIG. 5C, the step S230 and the step S250 may be performed repeatedly in a similar manner. For example, a second input signal for executing a second magnification mode may be provided from the input part 130. The display part 150 may display a third image 315 having a third data resolution of the numerical weather prediction model. The third data resolution may be higher than the second data resolution. The third image 315 may include a plurality of third unit images. For example, the third unit images may include a first sub-image H1, a second sub-image H2, a one hundred twenty-seventh sub-image H127, a one hundred twenty-eighth sub-image H128, an eight thousand sixty-fifth sub-image H8065, an eight thousand one hundred ninety-second sub-image H8192, etc. The first sub-image H1 may include a geographical point which is zero degree in longitude and +90 degrees in latitude. The first sub-image H1 through the eight thousand one hundred ninety-second sub-image H8192 of the third unit images may have an order in a latitude direction or in a longitude direction. The sub-images H1 through H8192 may include, for example, 256×256 grid resolution respectively which correspond to the pixel resolution of the display part 150. In the present example embodiment, the third image 315 may include 128 sub-images in a latitude direction and 64 sub-images in a longitude direction. Accordingly, the third image 315 may be displayed on a display area having 32768×16384 pixels P in the display part 150.

In the present example embodiment, the processor 110 may convert the resolution of the original data computed in the numerical weather prediction model into a low resolution corresponding to the 32768×163 84 pixels P. For example, if the resolution of the original data has a grid scale of 0.01 degrees×0.01 degrees (=about 1 km×1 km) in a latitude-longitude coordinates system, a number of grid points to represent the original data may be 36,000 in rows and 18,000 in columns. The processor 110 may convert the resolution of the original data into a low resolution of about 1/1.1 ratio. For example, about 1.2 values at about every 1.1×1.1 grid points may be interpolated into a single value at every grid point which is converted into the low resolution. In this case, the resolution of the original data of the numerical weather prediction model may be substantially maintain in the display part 150. In another example embodiment, the display part 150 may display the original data as its original resolution by executing a third magnification mode.

If the display part 150 has the pixel resolution of 1280×720 (i.e., HD-720 resolution), then the third image 315 may be displayed in about 25.6 inch×22.8 inch display area in the display part 150. If the display part 150 includes a display area smaller than about 25.6 inch×22.8 inch, only a portion of the third image 315 may be displayed on the display part 150 due to a size restriction of the display part 150.

As mentioned above, as a magnification level of the magnification mode increases, an image having a data resolution substantially the same as the resolution of the original data of the numerical weather prediction model may be displayed on the display part 150.

The magnification level of the magnification mode may be variously determined according to example embodiments. For example, the magnification level for the magnification mode may be determined as Table 1.

TABLE 1

| | No. of unit | No. of unit | No. of unit | No. of | No. of | |
|---|---|---|---|---|---|---|
| Magnification | images | images | images | pixels | pixels | No. of pixels |
| level | (row) | (column) | (total) | (row) | (column) | (total) |
| 1 | 8 | 4 | 32 | 2048 | 1024 | 2,097,152 |
| 2 | 16 | 8 | 128 | 4096 | 2048 | 8,388,608 |
| 3 | 32 | 16 | 512 | 8192 | 4096 | 33,554,432 |
| 4 | 64 | 32 | 2,048 | 16384 | 8192 | 134,217,728 |
| 5 | 128 | 64 | 8,192 | 32768 | 16384 | 536,870,912 |
| 6 | 256 | 128 | 32,768 | 65536 | 32768 | 2,147,483,648 |

Each of the unit images is assumed to include 256×256 pixels in Table 1. However, the number of pixels in one of the unit images may be altered in another example embodiment. In Table 1, a number of pixels for displaying numerical weather prediction model data may increase four times as a magnification level increases by one. Accordingly, all grid data of the numerical weather prediction model having an ultra-high resolution may be displayed in the display part 150.

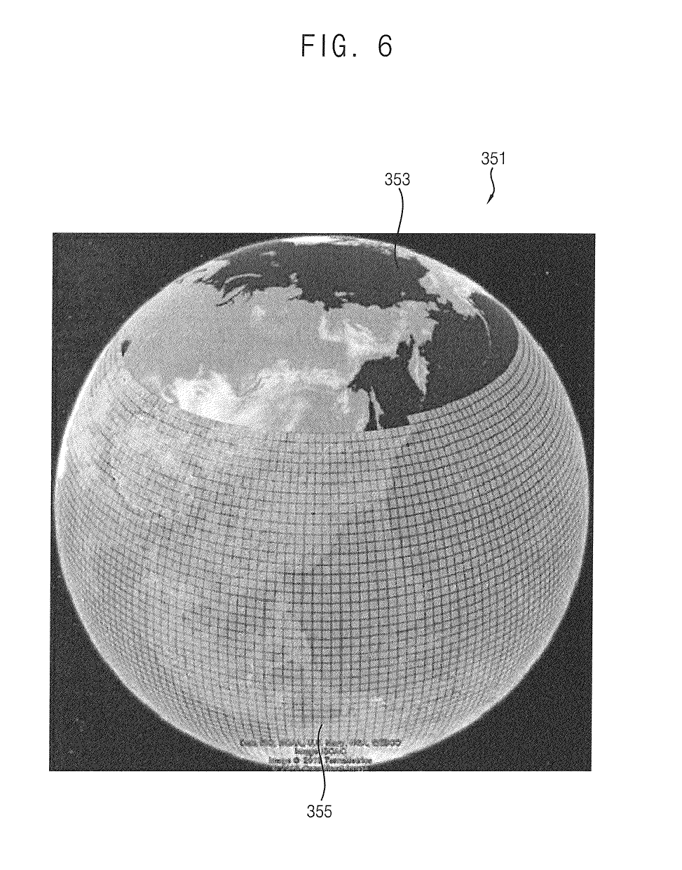

FIG. 6 is a perspective view illustrating a plurality of unit images in a spherical visualization of numerical weather prediction model data.

Referring to FIG. 6, numerical weather prediction model data may be visualized on a sphere 351. The sphere 351 may be divided by a plurality of unit areas 355. The unit areas 355 may correspond to about 65,000 (256×256) pixels, respectively. A plurality of unit images 353 may be displayed on the unit areas 355, respectively. Accordingly, the numerical weather prediction model data may be visualized globally on the sphere 351 to have a desired resolution.

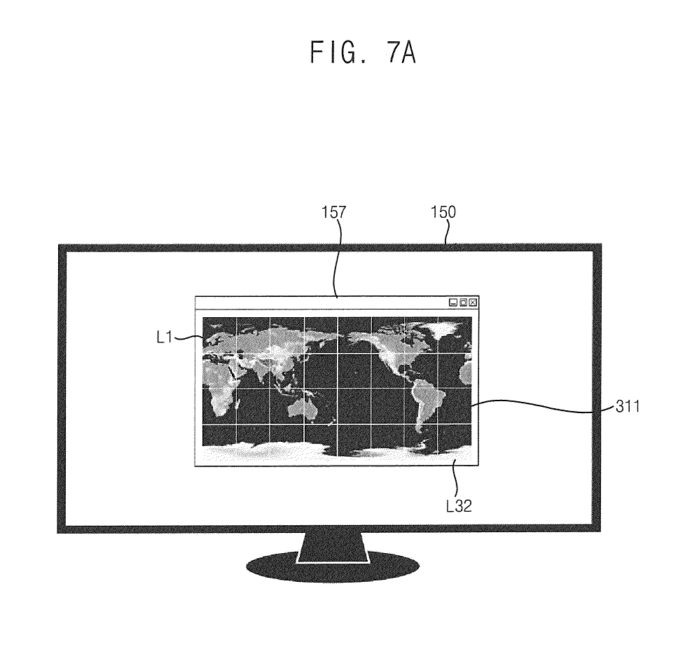

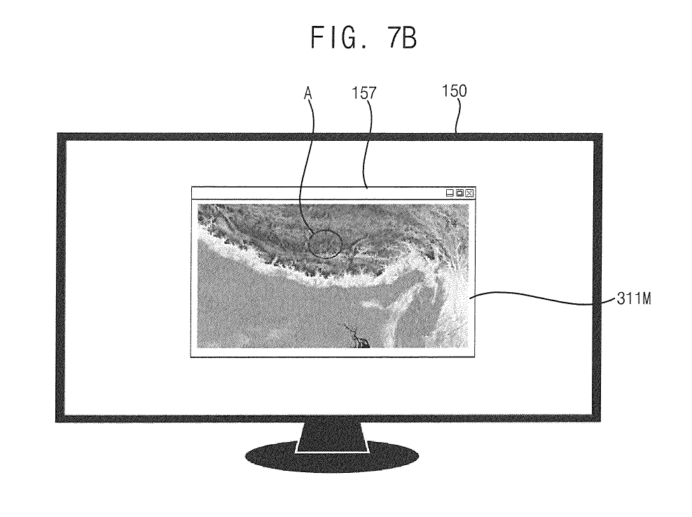

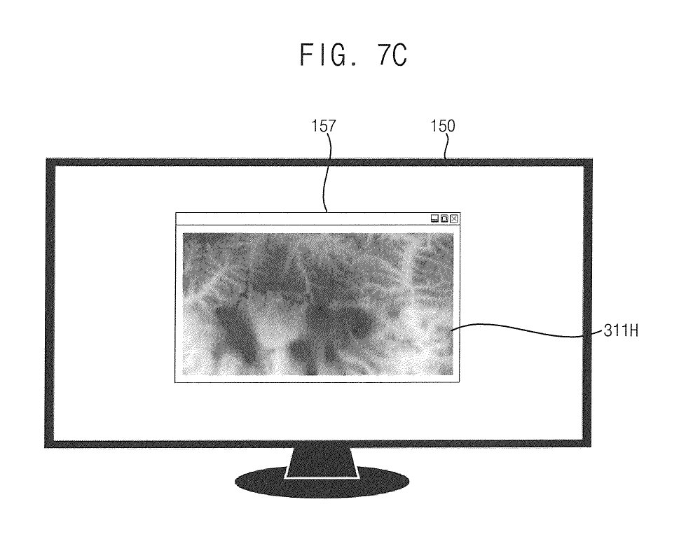

FIG. 7A, FIG. 7B and FIG. 7C are front views illustrating a display part which implements planar visualizations of numerical weather prediction model data having an ultra-high resolution respectively.

Referring to FIG. 7A, the display part 150 may display a display window 157 to visualize numerical weather prediction model data. A first image 311 having a first low resolution may be displayed within the display window 157. The first image 311 may include a plurality of unit images L1, L32, etc. arranged in a matrix shape. Although the unit images L1, L32, etc. are divided by border lines therebetween in FIG. 7A, the border lines are illustrated for ease of description. In another example embodiment, the first image 311 may be displayed as a single image without the border lines in the display part 150.

Referring to FIG. 7A and FIG. 7B, if a first input signal for executing a first magnification level is provided from the input part 130, a first magnified image 311M may be displayed in the display window 157. The first magnified image 311M may have a second low resolution higher than the first low resolution. Accordingly, a user may observe numerical weather prediction model data in detail at a desired geographical region.

Referring to FIG. 7B and FIG. 7C, if a second input signal for executing a second magnification level is provided from the input part 130, a second magnified image 311H may be displayed in the display window 157. The second magnified image 311H may have a grid resolution substantially the same as a data resolution of the numerical weather prediction model. Accordingly, the user may observe a local distribution of the numerical weather prediction model data in more detail. For example, a dark region A in FIG. 7B may be enlarged to display a relatively bright sub-region in FIG. 7C.

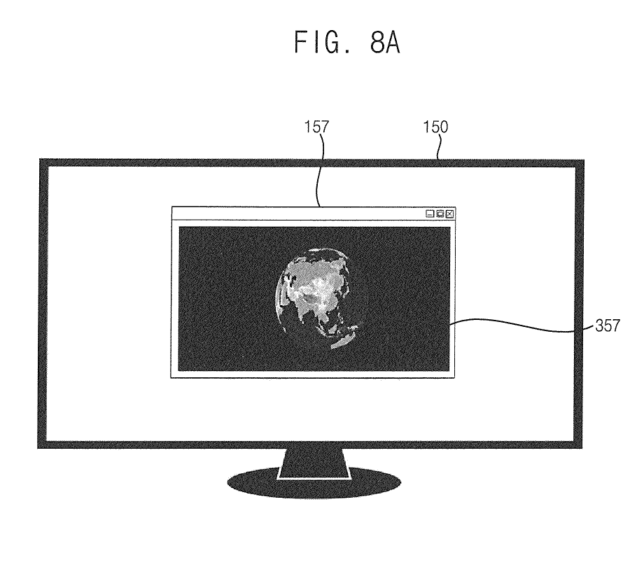

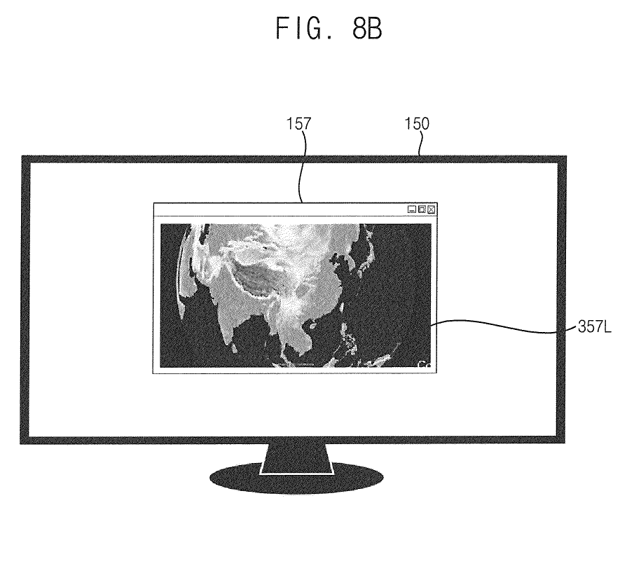

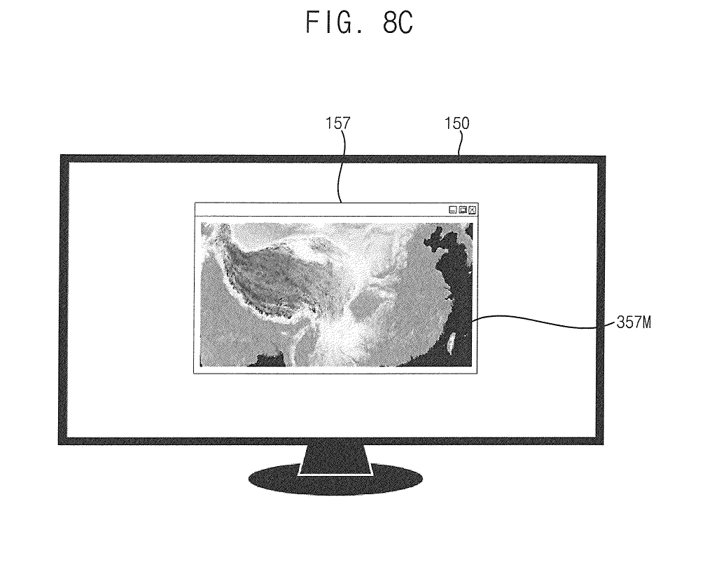

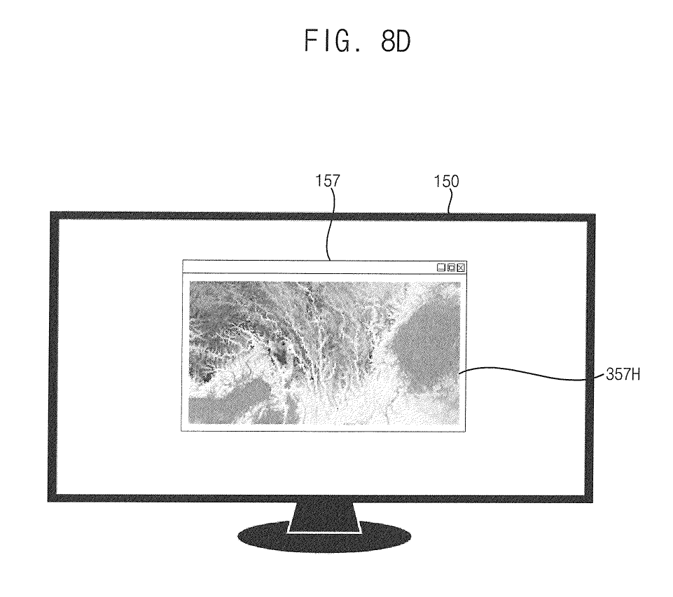

FIG. 8A, FIG. 8B, FIG. 8C and FIG. 8D are front views illustrating a display part which implements spherical visualizations of numerical weather prediction model data having an ultra-high resolution respectively.

Referring to FIG. 8A, the display part 150 may display a display window 157 to visualize numerical weather prediction model data. A first global image 357 having a first low resolution may be displayed within the display window 157. The first global image 357 may include a plurality of unit images arranged along grid lines in a spherical coordinates system such as, e.g., a latitude-longitude coordinates system, a cubed-sphere coordinates system, etc.

Referring to FIG. 8A and FIG. 8B, if a first input signal for executing a first magnification level is provided from the input part 130, a second global image 357L may be displayed in the display window 157. The second global image 357L may have a second low resolution higher than the first low resolution. Accordingly, the user may observe numerical weather prediction model data in detail at a desired geographical region.

Referring to FIG. 8B and FIG. 8C, if a second input signal for executing a second magnification level is provided from the input part 130, a first partial image 357M may be displayed in the display window 157. The first partial image 357M may have a third low resolution higher than the second low resolution. Accordingly, the user may observe numerical weather prediction model data in more detail at a desired geographical region.

Referring to FIG. 8C and FIG. 8D, if a third input signal for executing a third magnification level is provided from the input part 130, a second partial image 357H may be displayed in the display window 157. The second partial image 357H may have a grid resolution substantially the same as a data resolution of the numerical weather prediction model. Accordingly, the user may observe local distribution of entire grid data of the numerical weather prediction model in detail at a desired geographical region.

As mentioned above, according to one or more example embodiment of the visualization method of entire grid data of numerical weather prediction model having the ultra-high grid resolution by the magnification mode and the hardware device performing the same, numerical weather prediction model data having the ultra-high grid resolution may be displayed as a first resolution image including a plurality of unit images based on a magnification level of the magnification mode, thereby visualizing the numerical weather prediction model data without reducing accuracy of the numerical weather prediction model data regardless of the pixel resolution of the display part.

Also, a second resolution image including more unit images than the first resolution image may be displayed as the magnification level of the magnification mode increases, thereby easily representing local or global distribution of atmospheric and/or oceanic physical quantity.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

[EXPLANATION ON REFERENCE NUMERALS]

| | |
|---|---|
| 100: hardware device | 110: processor |
| 130: input part | 150: display part |
| 151: gate driving part | 153: data driving part |
| 155: display area | 157: display window |

What is claimed is:

1. A method of visualizing entire grid data of numerical weather prediction model having an ultra-high grid resolution by a magnification mode, wherein the method performed in a hardware device comprising a display part, a processor and an input part, the display part having a first pixel resolution, the processor being configured to provide the display part with an image signal, the input part being configured to provide the processor with an input signal, and the method comprising:
converting original data having a first data resolution computed in a numerical weather prediction model into a first low-resolution data having a second data resolution, the second data resolution being lower than the first data resolution;
displaying the first low-resolution data as a first entire image, the first entire image comprising a plurality of first unit images which corresponds to portions of the first low-resolution data;
converting the original data into a second low-resolution data having a third data resolution based on a first input signal, the third data resolution being lower than the first data resolution and higher than the second data resolution; and
displaying the second low-resolution data as a first partial image, the first partial image comprising a plurality of second unit images which corresponds to portions of the second low-resolution data.

2. The method of claim 1, further comprising:
converting the original data into a third low-resolution data having a fourth data resolution based on a second input signal, the fourth data resolution being lower than the first data resolution and higher than the third data resolution; and
displaying the third low-resolution data as a second partial image, the second partial image comprising a plurality of third unit images which corresponds to portions of the third low-resolution data.

3. The method of claim 2, further comprising:
displaying the original data as a third partial image based on a third input signal,
wherein the first data resolution is equal to the first pixel resolution.

4. The method of claim 1, wherein the third data resolution is four times greater than the second data resolution.

5. The method of claim 1, wherein the first data resolution has a horizontal grid scale between zero and 10 km in a side, and the second data resolution is between 1/100 and 1/10 of the first data resolution.

6. A hardware device comprising:
a processor configured to convert original data having a first data resolution computed in a numerical weather prediction model into a first low-resolution data having a second data resolution, the second data resolution being lower than the first data resolution;
a display part having a first pixel resolution and configured to display the first low-resolution data as a first entire image, the first entire image comprising a plurality of first unit images which corresponds to portions of the first low-resolution data; and
an input part configured to provide the processor with a first input signal for executing a first magnification mode,
wherein the processor is configured to convert the original data into a second low-resolution data having a third data resolution based on the first input signal, the third data resolution being lower than the first data resolution and higher than the second data resolution, and
wherein the display part is configured to display the second low-resolution data as a first partial image, the first partial image comprising a plurality of second unit images which corresponds to portions of the second low-resolution data.

7. The hardware device of claim 6, wherein the input part is further configured to provide the processor with a second input signal for executing a second magnification mode,
wherein the processor is further configured to convert the original data into a third low-resolution data having a fourth data resolution based on the second input signal, the fourth data resolution being lower than the first data resolution and higher than the third data resolution, and
wherein the display part is further configured to display the third low-resolution data as a second partial image, the second partial image comprising a plurality of third unit images which corresponds to portions of the third low-resolution data.

8. The hardware device of claim 7, wherein the input part is further configured to provide the processor with a third input signal for executing a third magnification mode,
wherein the processor is further configured to instruct the display part for displaying the original data as a third partial image based on the third input signal, and
wherein the first data resolution is equal to the first pixel resolution.

9. The hardware device of claim 6, wherein the third data resolution is four times greater than the second data resolution.

10. The hardware device of claim 6, wherein the first data resolution has a horizontal grid scale between zero and 10 km in a side, and the second data resolution is between 1/100 and 1/10 of the first data resolution.
